(19) United States
(12) Patent Application Publication
(10) Pub. No.: US 2003/0228522 A1
(43) Pub. Date: Dec. 11, 2003

(54) Method for preparing solid-state polymer zinc-air battery

(75) Inventors: Chun-Chen Yang, Taipei Hsien (TW); Sheng-Jen Lin, Taipei (TW); Chi-Neng Huang, Taipei Hsien (TW); Jung-Ming Chiu, Taipei Hsien (TW)

Correspondence Address: BRUCE H. TROXELL, SUITE 1404, 5205 LEESBURG PIKE, FALLS CHURCH, VA, 22041, US

(73) Assignee: Ming-Chi Institute of Technology

(21) Appl. No.: 10/219,327

(22) Filed: Aug. 16, 2002

(30) Foreign Application Priority Data
Jun. 3, 2002 (TW) 091111828

(51) Int. Cl. H01M 10/40; H01M 4/88; H01M 10/26

(52) U.S. Cl. 429/306; 502/101

(57) ABSTRACT

This invention relates to a method for fabricating solid-state alkaline polymer Zn-air battery, which consists of a zinc-gel anode, an air cathode electrode, and alkaline polymer electrolyte. The formulation of said zinc gel anode is similar to that of alkaline Zn—MnO₂ battery. The zinc gel anode contains a mixture of electrolytic dendritic zinc powders, KOH electrolyte, gelling agent and small amount of additives. The air cathode electrode is made by carbon gas diffusion electrode, which comprises two layers, namely gas diffusion layer and active layer. The active layer on the electrolyte side uses a high surface area carbon for oxygen reduction reaction and potassium permanganate and MnO₂ as catalysts for oxygen reduction. The diffusion layer on the air side has high PTFE content to prevent KOH electrolyte from weeping or climbing. Due to adequate amount of fresh air and oxygen supply, the air cathode electrode can run continuously. Theoretically, the polymer zinc-air battery is an accumulator if the cell has sufficient zinc powder and electrolyte, and the air cathode plays the role of energy transfer.

### BACKGROUND OF THE INVENTION

1. Field of the Invention

This invention relates to a method for preparing solid-state polymer Zn-air battery which uses environmentally friendly carbon material and zinc powder.

2. Description of the Related Art

Energy drives economic growth. It is also an important indicator gauging the strength and civilization of a country and living standard of its people. History illustrates that each innovative breakthrough in energy technology brought significant and profound influence on productivity and advancement of the civilization, demonstrating the importance of energy technology and its major influence on emerging industries.

Environmental protection has become an issue the human society is highly concerned about in the 21st century. It is the core issue in mapping out strategy for sustainable development and a key factor influencing the energy policy and technological orientation of countries. At the same time, it is a great propelling force behind the development of energy technology. The gigantic energy system we built up in the 20th century can not meet the requirements for high-efficiency, clean, economical and safe energy system for the future. In short, energy development is facing tremendous challenges ahead.

Energy production and consumption as well as global climate change are closely related to the greenhouse effect on earth. The current energy systems contribute to at least half of the greenhouse effect, that is, from carbon dioxide released after the burning of fossil fuel, which provides four fifths of the world's energy. The consumption of fossil fuel is continuously on the rise at the rate of 3% a year. Therefore the discharge of carbon dioxide also increases at the same speed. It is estimated that discharge of carbon dioxide will increase two folds by 2002 and three folds by 2025. Thus elevating energy utilization rate and developing alternative energy sources are highly important subjects in the 21st century.

Up to now, the majority of energy conversion is achieved through thermo-mechanical process. But constrained by Carnot cycle, thermo-mechanical process not only results in low conversion rate, leading to waste of energy, but also generates large amount of dust, carbon dioxide, NOₓ, SOₓ and other harmful substances as well as noise, leading to the pollution of air, water and soil and seriously threatening the living environment of mankind.

### SUMMARY OF THE INVENTION

To address the problem discussed above and in light that electrochemical process is the most effective means of converting chemical energy into electric energy, this invention purports to provide a solid-state polymer Zn-air battery that uses environmentally friendly materials.

Another objective of the invention herein is using solid-state polymer electrolyte in place of conventional liquid KOH electrolyte and separators to solve the battery leakage problem and allow the battery to be applied in light, thin, short and small 3C products.

A further objective of the invention herein is the use of electrolytically-prepared dendritic zinc powders with large surface area in zinc electrode that offers greater power, greater discharge rate and higher utilization percent of zinc; the solid-state polymer Zn-air battery of this invention shows impressively high energy density by volume and by weight at various testing conditions.

### BRIEF DESCRIPTION OF THE DRAWINGS

FIG. 1 is the state of solid PVA-GF polymer electrolyte of this invention observed by Scanning Electron Microscope (SEM);

FIG. 2 is a flow chart for preparing PVA-GF polymer electrolyte of this invention;

FIG. 3 shows the dendritic structure of electroplated zinc powder at current density of 250 mA/cm² and examined by SEM at 200×;

FIG. 4 shows the dendritic structure of electroplated zinc powder at current density of 250 mA/cm² and examined by SEM at 500×;

FIG. 5 shows the dendritic structure of electroplated zinc powder at current density of 250 mA/cm² and examined by SEM at 3000×;

FIG. 6 is the XRD of anode zinc powder in regular Zn-air battery;

FIG. 7 is the XRD of anode dendritic zinc powder of this invention;

FIG. 8 is a flow chart for preparing the dendritic zinc powder of this invention;

FIG. 9 is a flow chart for preparing the gelled zinc anode of this invention;

FIG. 10 is a sketch of air cathode electrode of this invention;

FIG. 11 is a flow chart for preparing the diffusion layer of air electrode of this invention;

FIG. 12 is the simplified process flow for preparing air electrode (active layer included) of this invention;

FIG. 13 is a sketch of electrochemical testing of air electrode of this invention;

FIG. 14 is a structural diagram of solid-state polymer Zn-air battery of this invention,

FIG. 15 is an AC resistance-impedance graph of PVA-GF film of this invention under different temperatures environment;

FIG. 16 is the Arrhenius plot of alkaline PVA-GF polymer electrolyte of this invention;

FIG. 17 is the cyclic voltammetry diagram of alkaline PVA-GF polymer electrolyte of this invention at different temperatures environment;

FIG. 18 shows the effect of storage time on the conductivity of solid-state PVA-GF polymer electrolyte of this invention;

FIG. 19 shows the potential versus time graph of electrolytic zinc prepared under constant current density;

FIG. 20 shows the polarization curve of air electrode of this invention at different temperatures environment;

FIG. 21 shows the AC resistance graph of air electrode of this invention at different temperatures environment;

FIG. 22 is the discharge curves of different Zn-air batteries (using different separators);

FIG. 23 is the microscopic structure of PP/PE separator used by regular Zn-air battery examined by SEM;

FIG. 24 is the microscopic structure of PVA-GF electrolyte of this invention examined by SEM;

FIG. 25 is the discharge curves of Zn-air battery of this invention under different discharge rates;

FIG. 26 is the discharge curves of Zn-air battery of this invention under different temperatures environment;

FIG. 27 is the AC resistance diagrams of Zn-air battery of this invention under different temperatures environment;

### DETAILED DESCRIPTION OF THE INVENTION

Preparation of Solid-State Alkaline Polymer Electrolyte

Along with the development of new technology, different kinds of polymer battery are now available in the market and applied in 3C products, turning thinner, lighter, and smaller products into market mainstream in the near future. Battery using solid polymer electrolyte offers many advantages in terms of safety, workability, and use in high temperature. There is no need to worry about leakage of electrolyte due to improper packaging or decrease of electrolyte in separator after the battery has been idle for a while, and the battery will maintain good performance under high temperature. That is why solid-state polymer battery represents a significant breakthrough in the future development of battery applications.

Polyvinyl alcohol (PVA) polymer is a water-soluble compound.

Glass fiber cloth (GF) is a fusion of silicon dioxide (SiO₂). Glass fiber yarn has flexibility and tensile strength increased by a dozen folds in comparison with regular glass. When used for reinforcement, this material is usually in superfine fibrous state that offers strength and excellent flexibility, and does not produce residual stress regardless of the shape of resulting product.

Glass fiber as reinforcement material possess the following properties:

1) High tensile strength which is twice that of steel wire having the same mass.

2) Dimensional stability: Under maximum stress, its unit dimensions changes by 3˜4% only.

3) High thermal resistance: It retains 50% of tensile strength under the temperature of 343° C.

4) Superior corrosion resistance: It exhibits excellent corrosion resistance and brittleness property when in contact with the majority of chemicals.

5) Excellent fire proofing: It does not burn (generate heat), nor smolder (generate smoke).

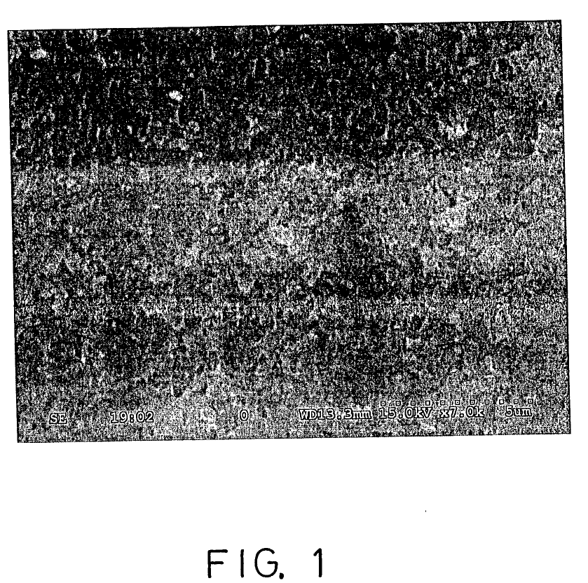

PVA polymer electrolyte has extremely high ion conductivity after processing, but its mechanical strength is not as good as ordinary PP/PE separators due to structural toughness. Thus glass fiber cloth is added in the preparation of PVA polymer electrolyte to greatly improve its mechanical strength up to five times that of ordinary separators and thermal stability without sacrificing its conductivity. It also solves the contraction problem after long-term storage. Due to the high mechanical strength of glass fiber cloth reinforced PVA polymer film, it is less prone to deformation during processing, charging and discharging of battery or battery packaging. Under scan electron microscope examination, the surface of PVA polymer film is free of large pin holes, but has many small holes with 0.1-0.2 μm in size. As shown in FIG. 1, when used in zinc-air battery, it blocks the entry of zinc ion into the air cathode electrode when the zinc anode discharges, thereby preventing the occurrence of short circuit problem that shortens the service life of battery. In addition, with the KOH electrolyte in gel state when dipped in PVA polymer, it helps solve leakage and corrosion problem of battery brought about electrolyte seeped through separator. Moreover, this polymer electrolyte retains high conductivity and electrochemical stability.

The PVA-GF polymer electrolyte of this invention is prepared by adding potassium hydroxide (KOH), water and glass fiber cloth to PVA solution under certain co-polymerization preparation conditions. Under ambient temperature, the conductivity of this PVA-GF polymer electrolyte reaches 10⁻¹ S/cm, indicating that zinc-air battery that uses this alkaline solid polymer electrolyte will perform better than commercial zinc-air batteries that use PP/PE separator. In addition, this polymer electrolyte may come in different thickness, size and shape to accommodate the battery requirements for size, capacity, and voltage.

The preparation of alkaline polymer electrolyte of this invention consists of five steps:

1) Select PVA and KOH materials and have PVA and KOH react with water separately;

2) Add the KOH solution to the PVA solution depending on the dissolution of PVA in water under controlled temperature and time;

3) Terminate the reaction depending on the set reaction time and the dissolution status of the mixture and then coat the polymer of different amounts on carrier or fiber glass to obtain films of desired thickness;

4) Control the film formation time, temperature and humidity to keep proper water content in the polymer film; and

5) Test the electrochemical property of solid alkaline polymer film produced thereof.

The procedure and method for preparing the PVA-GF polymer electrolyte of this invention are described in details as follows:

(1) Selection and Pre-Treatment of Raw Materials

Use PVA of 80˜99% purity with average molecular weight in the range of 2,000˜120,000, and preferably between 5,000 and 10,000, in either granule or powder form. Use potassium hydroxide of 85% purity in either granule or powder form.

(2) Reaction Sequence

The ratio of reactants and reaction sequence will directly affect the composition of polymer film and film formation. If the weight percentage of PVA is too high, dissolution will become difficult and conductivity will drop; if the weight percentage of PVA is too low, film formation might not occur. If the weight percentage of potassium hydroxide is too high, the resulting poor structure will make film formation difficult. If both of these materials are fed at the same time, neither will dissolve. Thus the proportion and dissolution sequence of the reactants are vital in the polymer film process. This inventor finds that mixing 10˜20 wt % PVA with 50˜60 wt % water under ambient temperature and in a closed environment for approximately two hours will result in complete dissolution. At the same time, adding 15˜25 wt % potassium hydroxide to 10˜20 wt % water under ambient temperature and in a closed environment to undergo mixture and dissolution.

(3) Control of Polymer Blending Conditions

The temperature and time of polymerization reaction will affect the water content of polymer film; the higher the water content, the higher the conductivity. But polymerization will only occur under specific temperature. Thus the control of polymerization time and reducing the loss of water are vital. This invention mixes completely the dissolved PVA solution and the potassium hydroxide solution under ambient temperature. At this time, white solid matter results. Mix it with the solutions thoroughly and heat the solutions in closed container under 50˜100° C. with the option of adding some micro or nano-particle oxides, such as γ-Al₂O₃, TiO₂, ZrO₂, and SiO₂ to improve the physical and chemical properties of the polymer. Let the reaction go on for about 30 minutes until the solid matter is completely dissolved. Cool the solution in atmosphere. After the solution is cooled, coat the alkaline polymer fluid on the carrier (e.g. glass fiber cloth or PTFE membrane) to obtain film of desired thickness.

(4) Film Formation Conditions

Cut glass fiber cloth of proper size and lay it flat on the carrier tray. Pour the viscous alkaline polymer solution into it and spread the solution according to the desired film thickness. Put the carrier tray into the temperature/humidity chamber under 40˜80° C. and 30˜50 RH % (optimum conditions are 50˜60° C. and 20˜30 RH %) for about 30˜60 min until solid polymer film is formed. Then take out the carrier tray and leave it in atmosphere for 30 minutes before removing the film.

(5) Testing the Electrochemical Properties of Alkaline Polymer Electrolyte

(i) Testing of Conductivity

Measure the resistance of solid alkaline polymer electrolyte with Autolab FRA AC impedance analyzer and dipolar stainless steel electrodes with frequency scan between 100 kHz˜0.1 Hz with amplitude of 10 mV. Also calculate the conductivity of the polymer electrolyte with σ=L/(R_{_{b}}_{×A)}. At the left side high-frequency area of Nyquist graph, the impedance value that intersects Z′ axis with Z″ axis (capacitance) at zero is the resistance of polymer electrolyte film (R_{b}).

(ii) Testing of Electrochemical Stability

Use Autolab GPES system to measure the cyclic voltammetry of this polymer electrolyte and other types of separators. The potential range is −1.5˜1.5V, the scan rate is 1 mV/s and stainless steel (SS-316) is used as working electrode and Hg/HgO electrode as a reference electrode.

(iii) Testing of Electrical Property of Battery

Assemble a Zn-air battery using the PVA-GF polymer electrolyte of this invention and a zinc electrode (−) and the air electrode (+); the electrode area is about 6 cm² (2 cm×3 cm). Discharge current at 50 mA, 100 mA and 200 mA, respectively and compare the electrical performance of batteries with different separators.

(iv) Computation of Chemical Composition of PVA-GF Alkaline Polymer Film

Use mass balance method to compute the composition ratio of PVA-GF polymer electrolyte before and after reaction.

(v) Computation of Activation Energy (Eₐ)

Graph log σ versus 1/T in Arrhenius plot to obtain slope, and then calculate activation energy (Eₐ).

σ=σₒ exp(−Eₐ/RT), or log σ=log σₒ−Eₐ/(2.303×1000R)×1/T (1)

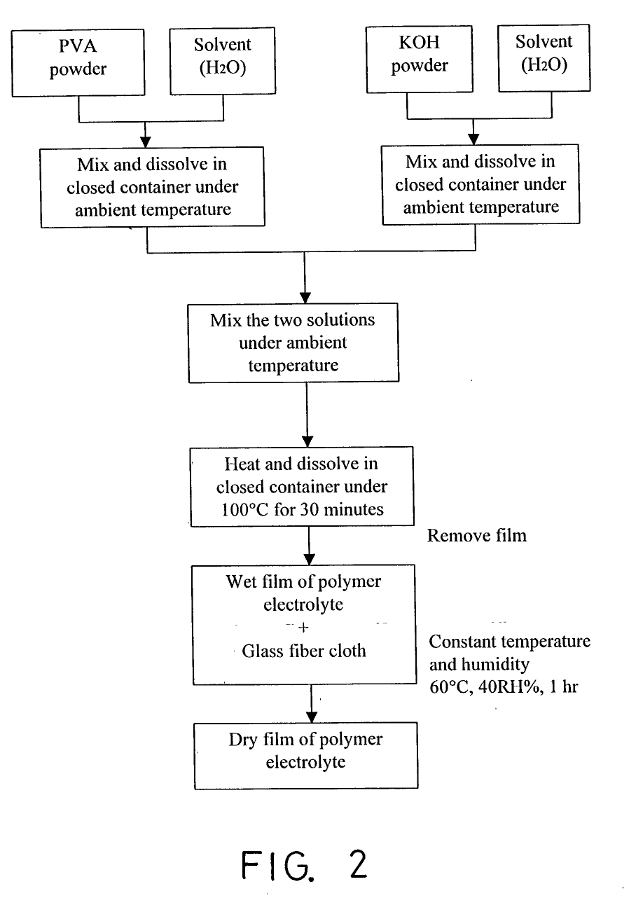

The preparation process flow for solid alkaline PVA-GF polymer electrolyte is shown in FIG. 2.

Preparation of Zinc Gel Anode

Zn-air battery may replace the commercially available alkaline cells as a primary cell with high energy density. Zinc powder plays the most important role in zinc-air battery, which decides capacity, current density, flat discharge voltage, self-discharge rate and battery cost, essentially all factors that determine the performance of a battery. To enhance the utilization rate of zinc powder, this invention aims to develop dendritic zinc powder, for it offers good ductility, higher surface area, and smaller particles. After discharge of zinc electrode, the zinc powder converts into zinc oxide, zinc oxide powder may be recycled to form zinc powers. On the other hand, recycling can also help reduce environmental pollution. Thus this invention uses alkaline KOH solution as a solvent to dissolve zinc oxide and the resulting mixture is electroplated under certain conditions to produce high porous dendritic zinc powder. There are many control variables in the preparation process, such as current density, concentration of zinc oxide in the electrolyte, temperature, additives, mass transfer conditions, and drying time. Thus the whole process must be carried out under specific operating conditions to obtain dendritic zinc powder with optimum electrical and chemical characteristics.

To make good performance of Zn-air battery, zinc powder is the key material in deciding its service life and performance. Zinc powder used by commercially available battery has large-size particles around 300-600 μm and is widely distributed that keeps the battery from working under large current load and results in lower utilization percent of zinc powder. This invention provides the method of preparing porous dendritic zinc powder with high specific surface area and low density, which may be applied in many alkaline battery, such as zinc-air battery and zinc-system battery (e.g. Zn—MnO₂, Ni—Zn, Fe—Zn, Zn—Br₂, etc.), and many recycled zinc oxide, thus improring the performance of battery, lowering costs, and friendly to the environment.

Process for Preparing Electrolytic Dendritic Zinc Powder

(1) Testing the Solubility of Zinc Oxide

Dissolve zinc oxide of different percentages into KOH solution of 1˜10M under the temperature between 25˜60° C. and 50˜80 RH %, then measure the solubility of zinc oxide. The solubility of ZnO in KOH is constrained by thermodynamic equilibrium. Experiments find that the solubility of ZnO in KOH solution is about 6-7%. Thus this invention uses 7 wt % of ZnO in preparing dendritic zinc powder by electroplating.

(2) Solubility of Zinc Oxide

Remove the oxidized zinc anode from zinc-air battery. Separate zinc oxide powder from current collector using mechanical means and then place it in KOH solution to produce K₂Zn(OH)₄ aqueous solution.

(3) Preparation of Dendritic Zinc Powder

Subject K₂Zn(OH)₄ aqueous solution to electrolysis under different conditions and environment to produce dendritic zinc powder, which is then electroplated at different temperatures (30, 50, and 70° C.) and specific current density of 100˜250 mA/cm². It is found that temperature has significant influence on the micro-structure of electroplated zinc powder; the higher the temperature, the larger the powder particle size and the higher the electroplating efficiency.

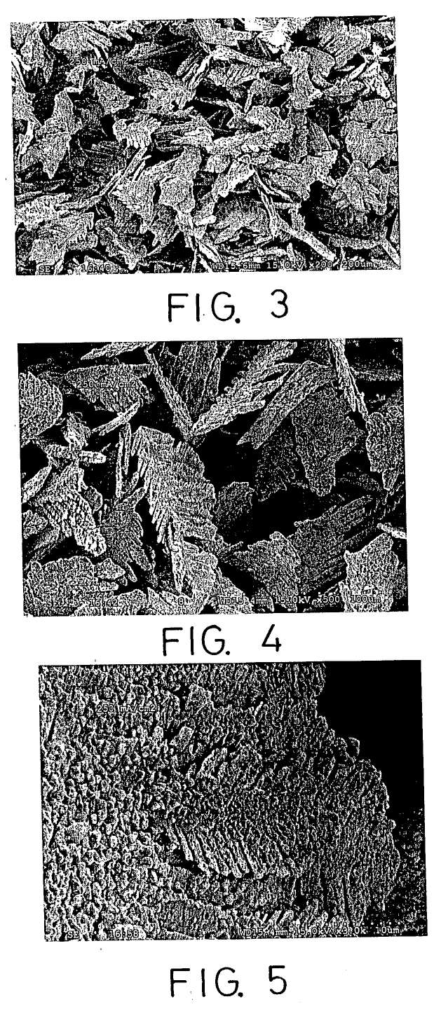

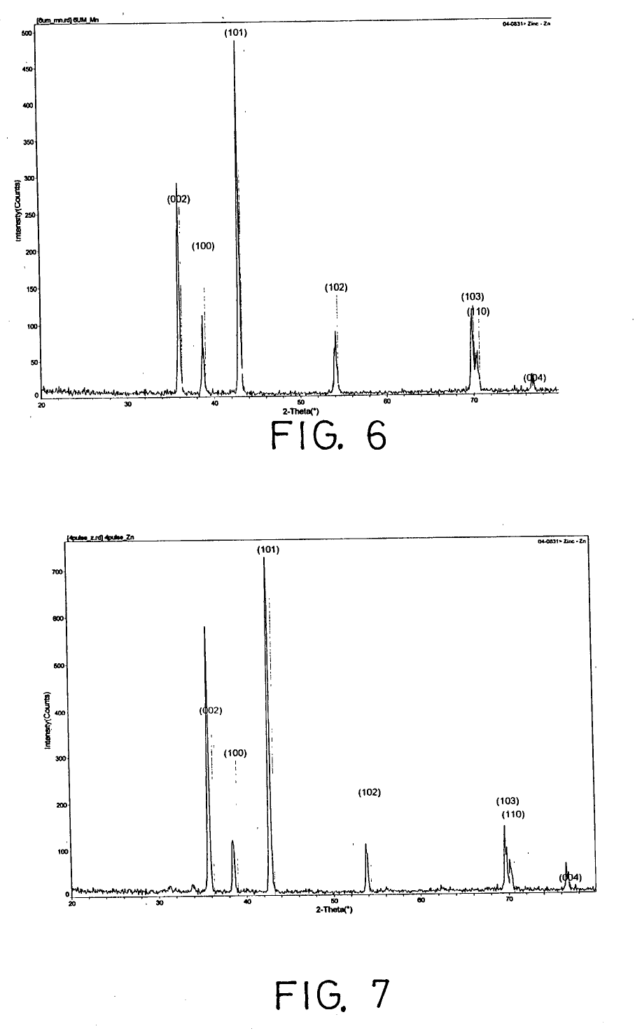

FIGS. 3-5 depict the dendritic structure of electroplated zinc powder under current density of 100˜250 mA/cm². FIG. 6 and FIG. 7 are the XRD diagrams of ordinary zinc powder and dendritic zinc powder, respectively.

(4) Treatment After Electroplating

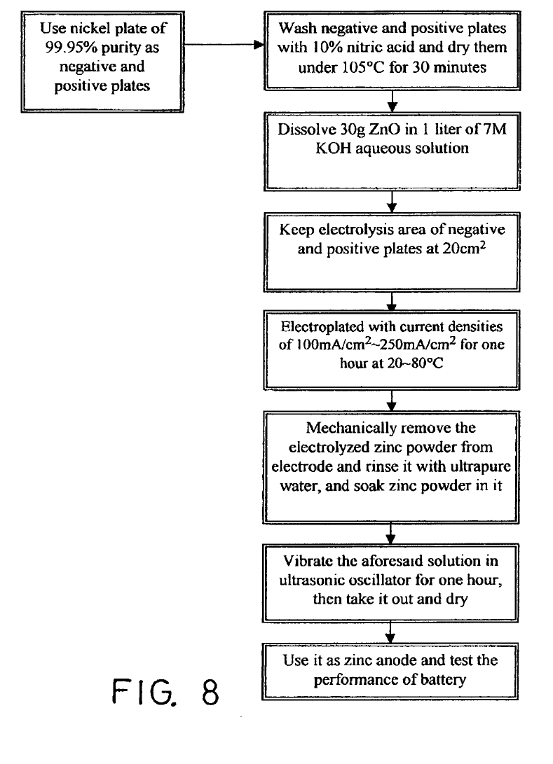

Post-electrolysis treatment of dendritic zinc powder is a highly important process. If the residues of KOH solution on the surface of zinc powder are not removed completely, the zinc powder will be oxidized into ZnO in the drying process, rendering it useless. Thus the post-electroplating treatment must be dealt with great prudence. The treatment process entails the following steps: scrap electroplated zinc powder off from the negative plate and wash it with ultra-pure water, clean with ultrasound for 30 minutes and filter, then repeat the washing process until the zinc powder is thoroughly cleansed off residual KOH electrolyte. After the zinc powder is dried, seal it with zipper bag and place it in oven to prevent the oxidation of zinc. FIG. 8 illustrates the preparation process for porous dendritic zinc powder with large surface area.

(5) Preparation of Zinc Gel Anode

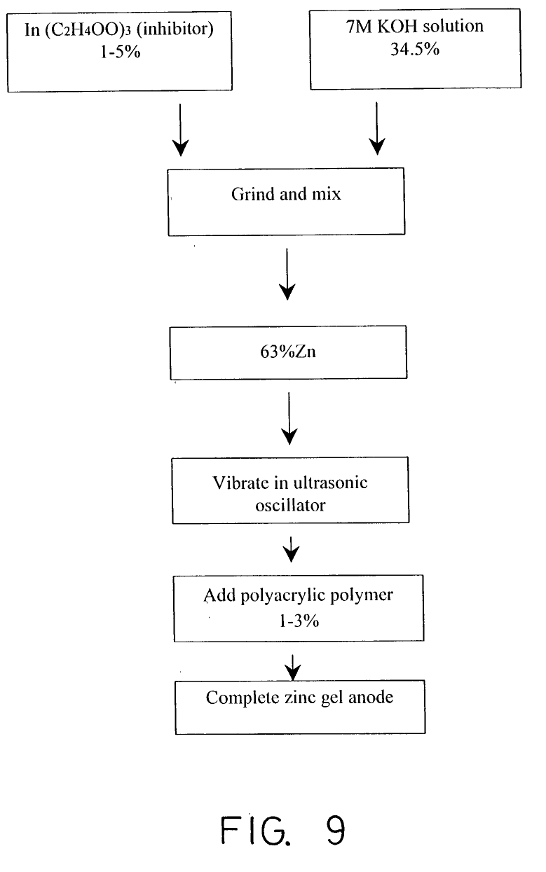

Weigh proper amount of inhibitor In(Ac)₃ and add it in KOH solution. Agitate the solution to let the inhibitor distribute evenly. Add proper proportion of dendritic zinc powder into the gel solution just prepared, and add proper amount of ZnO according to design requirement. Put the aforesaid solution in ultrasonic device for one hour. Add in proper amount of poly-acrylic polymer gelling agent and agitate evenly to obtain highly viscous gel without air bubble. This completes the preparation of zinc anode. The preparation process for zinc gel anode is depicted in FIG. 9.

Process for Preparing the Air Electrode

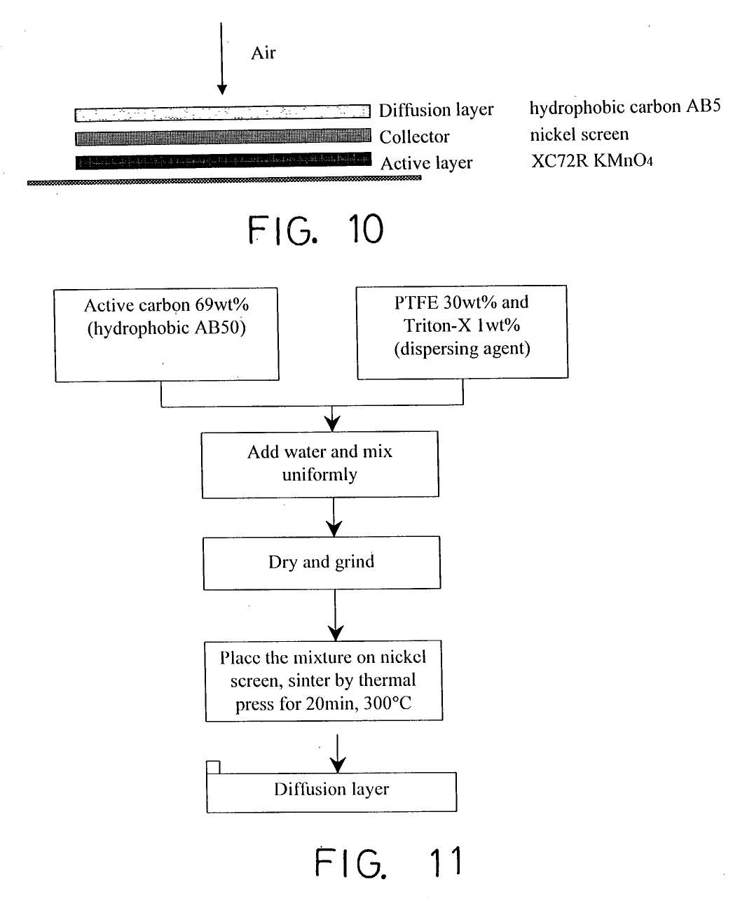

Zn-air battery needs an effective air cathode electrode to work. This invention focuses on developing technology for highly efficient, thin, air cathode electrode, which entails the development of better catalyst, electrode structure with longer life, and lower production costs. FIG. 10 illustrates the structural diagram of an air cathode electrode. The air cathode electrode consists of a carbon diffusion layer, nickel screen current and an active layer pressed together, and is separated from the zinc anode by a separator. The diffusion layer of air electrode is made of hydrophobic activated carbon and nickel-screen collector, whereas the active layer is made of hydrophilic carbon powder plus catalysts (KMnO₄ and MnO₂).

Given the oxygen in air cannot act as an electrode to accept electron and undergo reduction reaction, it needs to undergo reaction through a carbon electrode made of active carbon carrier. The active carbon carrier does not participate in electrode reaction, but provides a venue for oxygen to undergo cathode reduction. Air cathode electrode is less active in acidic and neutral medium, and the electrode materials and the catalyst are prone to corrosion in acid medium. Therefore air cathode electrode in alkaline electrolyte is more extensively applied at the present time.

The equation for electrochemical reduction of oxygen in alkaline electrolyte is as follows:

O₂+2H₂O+4e⁻→4OH⁻(/), E⁰=0.410 V (vs. SHE)

Air cathode electrode has smaller exchange current density (iₒ) that makes the establishment of balanced potential difficult and its polarization is more serious under load.

The air cathode electrode is primarily a carbon electrode where oxygen is dissolved and adhered on its surface to undergo electrochemical reaction. But oxygen's solubility in alkaline solution is small. To increase the working current density of the Zn-air electrode and reduce polarization that will help increase the real surface area of electrode and reduce the boundary thickness of liquid phase transfer. The porous diffusion electrode is designed to meet these requirements. Keeping the stability of reaction zone (usually referred to as tri-phase interface reaction) inside the porous gas diffusion electrode is an important issue. In cohesive gas diffusion electrode, water repellent (e.g. polytetrafluoroethylene, PTFE) is used to give the electrode certain hydrophobicity and to keep the triphase interface stable. The level of polytetrafluoroethylene is usually at 5˜10 wt %. Too much water repellent will lower the conductivity of electrode, affecting the battery performance. For Zn-air battery that uses solid electrolyte, such as PVA-GF alkaline solid polymer, some solid-state metal oxide may be added to the electrolyte to improve the stability of interface.

Air gas diffusion electrode is an electrode with certain porosity and high specific surface area and able to form stable tri-phase interface system. That is why its reaction mechanism is more complicated, which usually comprises the following steps:

Diffusion of gas→diffusion→chemical absorption→electrochemical reaction→products diffused into solution.

Generally speaking the air cathode electrode has gas on one side and electrolyte on the other. The liquid at tri-phase interface forms meniscus on capillaries of the electrode and adheres to the extremely thin film on electrode surface. Although O₂ gas has very low solubility and diffusion in liquid, oxygen is still able to penetrate the film to reach the electrode at normal speed due to the thinness of the film. To reach triphase stability inside the electrode, its capillaries may not be fully filled with electrolyte and at the same time must allow the entry of KOH electrolyte into them.

Ordinary electrode materials and catalyst are hydrophilic. But to meet the requirement where the capillaries on electrode surface is neither completely “dry”, nor completely “moist”, so as to establish a stable tri-phase interface, water repellent must be added to change the contact angle of electrode surface. Therefore the gas diffusion electrode must contain at least three layers, i.e. water-proof layer, collecting network, and active layer.

The method for preparing the air cathode electrode of this invention is presented as follows:

(1) Preparation of Gas Diffusion Layer

a) Take proper amount of Triton-X surfactant, PTFE-30 solution and H₂O, and mix them uniformly, and then put the mixture together with the vessel into ultrasonic device and vibrate for 10 minutes (to let PTFE, H₂O and Triton X mix uniformly);

b) Add weighed AB50 carbon powder to the mixture, agitate manually and then put the mixture in ultrasonic device to vibrate for 30 minutes, then place the mixture in oven to dry at 120° C. (to remove H₂O completely);

c) The resulting dried materials will be lumped together; grind the lump uniformly and weigh proper amount based on the size of the air electrode;

d) Put the nickel screen in the die fixture and coat the materials uniformly on the screen;

e) Put the die in thermal press and sinter under constant pressure based on parameter requirements (time, temperature and thickness). Afterwards, send the die to cooler, remove the diffusion layer after it is cooled and wait for the spraying of active layer. (See FIG. 11).

(2) Preparation of Active Layer

a) Weigh XC-72R carbon powder and add in proper amount of catalysts KMnO₄ and MnO₂;

b) Oscillate weighed PTFE-30 and H₂O ultrasonically for 5 minutes (to mix them uniformly);

c) Add the material in step a. into that in step b) and agitate with the aid of ultrasonic device;

d) Add in proper amount of methanol and iso-propanol; agitate manually and then with the aid of ultrasonic device for 30 min (in liquid state for spraying purpose). Spray the resulting liquid on diffusion layer according to the amount required amount;

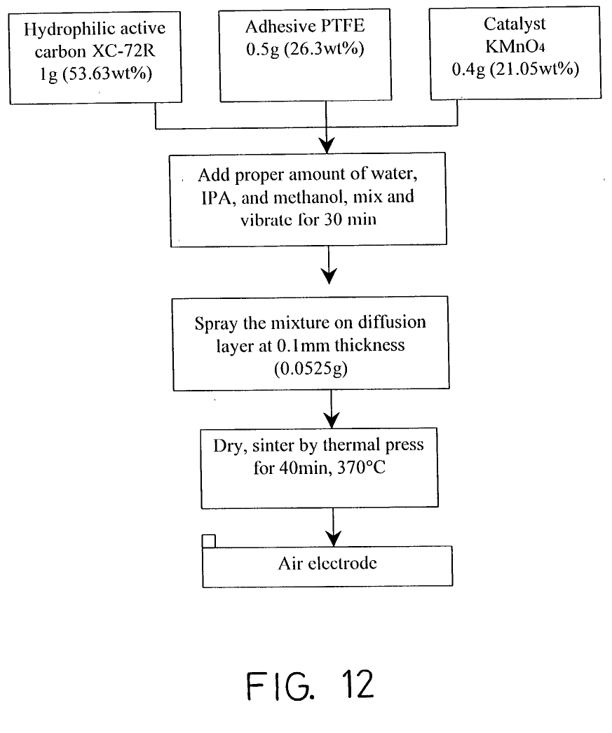

e) Subject the aforesaid the air cathode electrode to high-temperature sintering, then let it cool under constant pressure. (See FIG. 12).

(3) Electrical Testing of Air Cathode Electrode

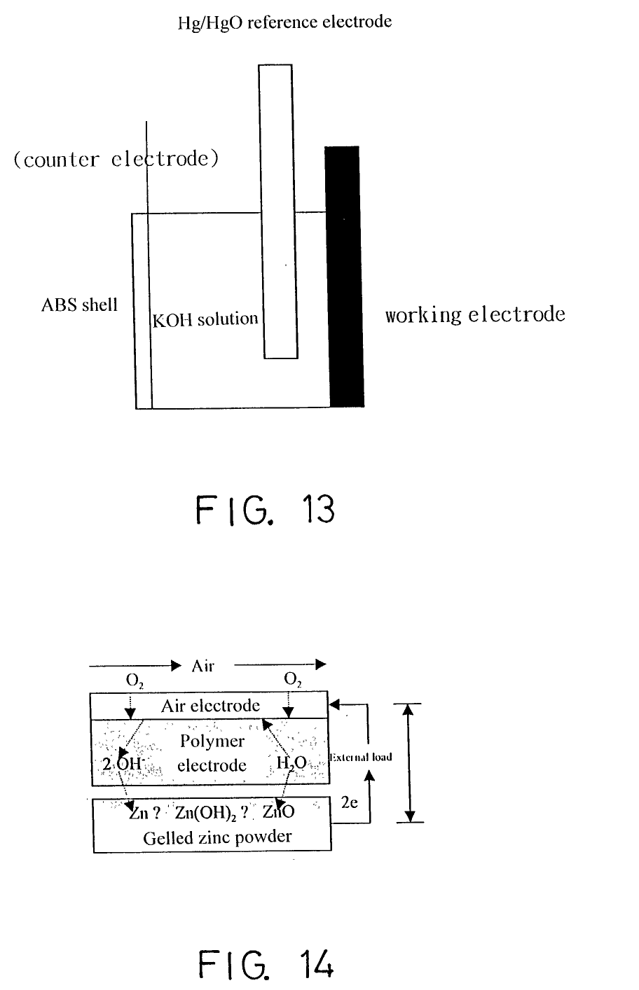

In the electrical testing of the air electrode, scan from open-circuit voltage (E_{ocv}) in the direction of cathode direction to obtain I-V polarization curve. For testing, apply two ABS boards each to the exterior of both sides of air cathode electrode and control their reaction area with 1 cm² to measure the current density (mA/cm²) of the air electrode under different potentials. The testing set-up of three-electrode system on the air electrode is depicted in FIG. 13.

Assembly of Solid Polymer Zn-Air Battery

The solid-state alkaline PVA-GF polymer electrolyte, zinc anode gel and air cathode electrodes of this invention are assembled into a polymer Zn-air battery of prismatic type, which may be applied to handset, PDA, PHS and other 3C electronic products. To determine the performance of the assembled Zn-air polymer battery, this invention will explore the effect of temperature, separator and discharge rate on the electric properties of the battery. FIG. 14 is a structural diagram of polymer Zn-air battery of this invention.

The electrode reactions of the polymer Zn-air battery are as follows:

| | |
|---|---|
| Anode: | |
| Zn + 4OH⁻ → Zn (OH)₄⁻² | E⁰ = −1.25 V |
| Zn(OH)₄⁻² → ZnO + 2OH⁻ + H₂O | |
| Cathode: | |
| O₂ + 2H₂O + 4e⁻ → 4OH⁻ | E⁰ = +0.40 V |
| Overall: | |
| 2Zn + O₂ → 2ZnO | E⁰ = 1.65 V |

### BRIEF DESCRIPTION OF THE PREFERRED EMBODIMENT

The present invention is further depicted with the illustration of embodiments.

Embodiment 1 Synthesis of PVA-GF Solid-State Alkaline Polymer Electrolyte

Weigh accurately 8.0 g of polyvinyl alcohol (PVA) and 40 g of water and place them into reactor. Measure the weight of reactor with PVA, water and agitator in it and record it. Agitate for one hour under ambient temperature until PVA is completely dissolved. Dissolve 12.5 g of potassium hydroxide (KOH) in 10 g of water and then pour it into the reactor. Raise the reactor temperature to 70° C. and control the polymerization time to under 30 min. Measure the weight of reactor with resulting polymer inside and record it, and spread viscous polymer of specific weight (about 5˜10 g polymer solution) on glass fiber (GF) and place it in temperature/humidity chamber (control the humidity at 40 RH % and temperature at 60° C.) for one hour. After that, take it out and leave it in atmosphere for 30 min to one hour. Remove the alkaline polymer film and weigh it to calculate its chemical composition after drying. Preserve the polymer film in zipper bag.

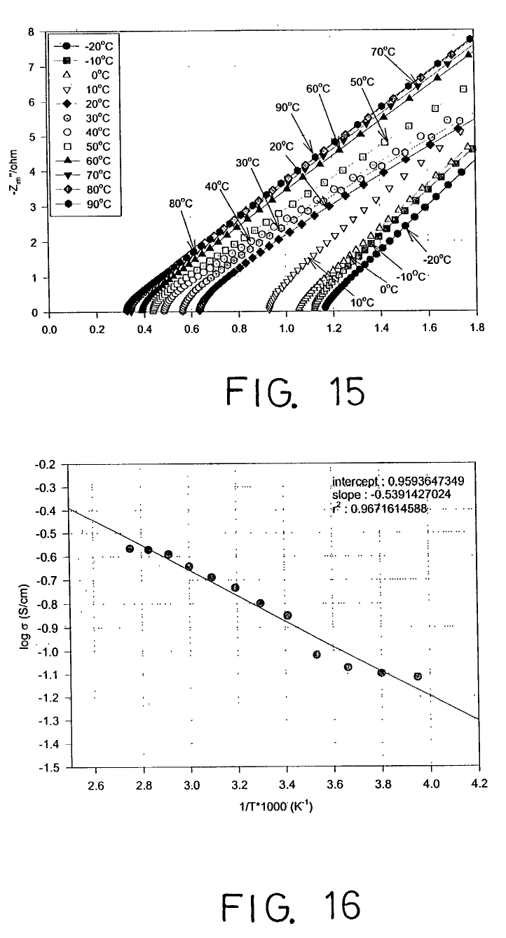

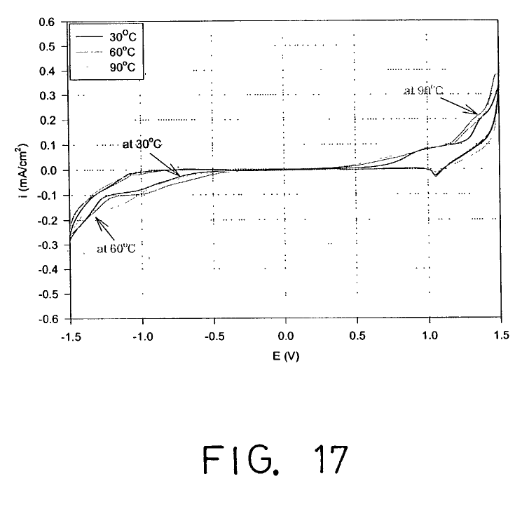

Measure the thickness of PVA-GF polymer film obtained above with digital thickness gauge and its ionic conductivity and cyclic voltammetry with Autolab FRA (bipolar stainless steel electrodes). The result of resistance analysis is as shown in FIG. 15, and the result of Arrhenius plot is presented in FIG. 16. The figures show that the conductivity of PVA-GF polymer electrolyte of this preferred embodiment under ambient temperature was 0.1408 S/cm, its activation energy for reaction was 10 kJ/mole, which is much lower than the activation energy of Li PEO polymer electrolyte proposed by M. R. Armand (22˜30 kJ/mole). Table 1 displays the change of conductivity of PVA-GF electrolyte under different temperatures. From the cyclic voltammetry shown in FIG. 17, it is learned that in comparison with PVA-GF polymer electrolyte and PP/PE separator, the PVA-GF polymer electrolyte in this preferred embodiment did not undergo any oxidation and reduction reaction within working voltage window of −1.4˜1.4V, i.e. there was absence of faradic current flow. Based on the test results, PVA-GF electrolyte exhibited better electrochemical stability than commercially available PP/PE separator (voltage stability of −1.0V˜1.0V) and cellulose separator (voltage stability of −1.2˜1.2V) with a broader range of electrochemical voltage (i.e., 2.8V window range).

TABLE 1
Conductivity of PVA-GF polymer electrolyte at different temperatures

Parameter

| T(° C.) | Impedance (ohm) | Conductivity (S/cm) |
|---|---|---|
| −20 | 1.1663 | 0.0765 |
| −10 | 1.1201 | 0.0796 |
| 0 | 1.0542 | 0.0846 |
| 10 | 0.9294 | 0.0959 |
| 20 | 0.6335 | 0.1408 |
| 30 | 0.5616 | 0.1588 |
| 40 | 0.4829 | 0.1847 |
| 50 | 0.4364 | 0.2043 |
| 60 | 0.3925 | 0.2272 |
| 70 | 0.3474 | 0.2567 |
| 80 | 0.3324 | 0.2683 |

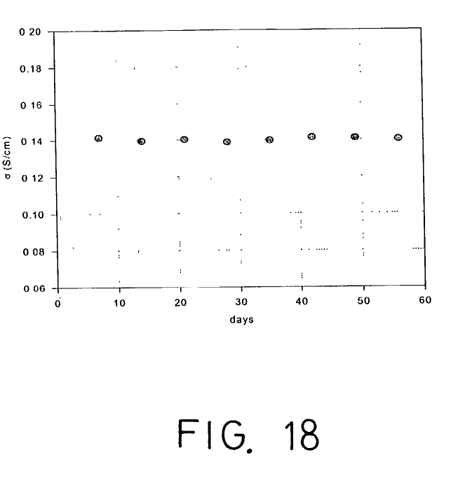

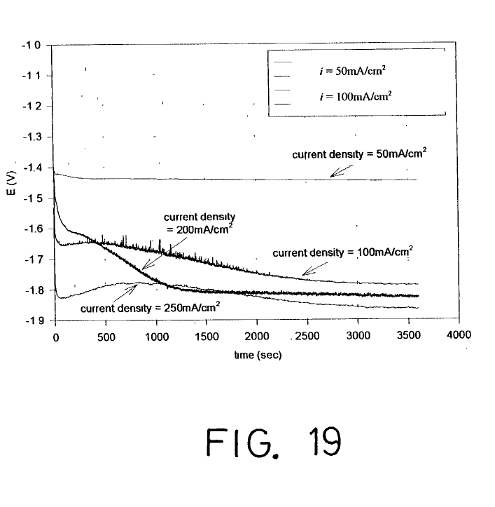

Put PVA-GF polymer film above in zipper bag and place it under constant environment of 25° C. and 60% RH and measure its conductivity once a week to test the effect of time of conductivity. FIG. 18 shows that the conductivity of the polymer electrolyte did not show significant change along with the progression of time, and was maintained around 0.1 S/cm. This result indicates that the PVA-GF polymer electrolyte has excellent stability. Table 2 illustrates the conductivity of PVA-GF electrolyte at different times.

TABLE 2
Conductivities of PVA-GF electrolyte

| | No. of days | | | | | | | |
|---|---|---|---|---|---|---|---|---|
| Conductivity | 7 | 14 | 21 | 28 | 35 | 42 | 49 | 56 |
| σ (S/cm) | 0.1413 | 0.1394 | 0.1402 | 0.1387 | 0.1396 | 0.1411 | 0.1408 | 0.1401 |

Embodiment 2 Preparation of Dendritic Zinc Powder

Select nickel plate as negative and positive plates and dissolve 7 wt % of ZnO in 8M KOH aqueous solution. Carry out electroplating for one hour under different temperature (30° C., 50° C., 70° C.) and at different current densities (50 mA/cm², 100 mA/cm², 200 mA/cm², and 250 mA/cm²). Post-electroplating treatment of dendritic zinc powder is a highly important process; scrap electroplated zinc powder off from the negative plate and wash it with ultra-pure D.I. water, vibrate with ultrasound device for 30 min and filter, then repeat the washing until the zinc powder is thoroughly cleansed off residual electrolyte. After the zinc powder is dried, seal it with zipper bag and place it in oven to prevent the oxidation of zinc.

FIG. 19 is the graph of plating potential vs. time at constant current. It is learned that the higher the current density, the greater drop of potential, that is, the more serious the polarization and representing greater consumption of energy. Table 3 depicts the plating efficiency of zinc powder under different current densities. It is found that the electroplated zinc powder at current density of 200 mA/cm² had the highest efficiency (84.70%) and consumed less energy. In addition, the densities of zinc powder were less than 7.13 (g/cm³) within the range of 4.8˜5.4 (g/cm³), mainly because the porous dendritic zinc powder has very high specific surface area.

TABLE 3
Faraday efficiency and electroplated dendritic zinc powder density
at different current densities

| | Parameter | | | |
|---|---|---|---|---|
| | Theoretical | Actual weight | | |
| | weight of zinc | of zinc | Faraday | Zn powder |
| i(mA/cm²) | powder (g) | powder (g) | efficiency | density (g/cm³) |
| 100 | 0.7308 | 0.3745 | 51.24% | 4.76 |
| 166 | 1.2180 | 0.7046 | 57.85% | 5.08 |
| 200 | 1.8270 | 1.5482 | 84.70% | 5.26 |
| 250 | 1.4616 | 1.1239 | 76.89% | 5.42 |

Embodiment 3 Preparation of Zinc Gel Anode

Weigh 1% In(Ac)₃ inhibitor and add in 7M KOH solution. Agitate the solution to let the inhibitor distribute evenly. Mix 20 wt % dendritic zinc powder, 80 wt % molten zinc alloy powder into the gel just prepared. Vibrate the aforesaid solution in ultrasonic device for one hour. Add in proper amount of poly-acrylic polymer gelling agent (e.g. CMC, PVA, and capabol) and agitate evenly to obtain highly viscous gel. This completes the preparation of zinc gel anode.

### Embodiment 4 Preparation of Air Electrode

Take proper amount of Triton-X, PTFE-30 solution and H₂O, mix them uniformly, and then put the mixture together with the vessel into ultrasonic device and vibrate for 10 min (to let PTFE, H₂O and Triton X mix uniformly). Add weighed AB50 carbon powder to the mixture, agitate manually and then put the mixture in ultrasonic device to vibrate for 30 min, then place the mixture in oven to dry at 120° C. (to remove H₂O completely). The resulting dried materials will be lumped together; grind the lump uniformly and then coat the material uniformly on the nickel screen current collector in the die. Put the die in thermal press and sinter under constant pressure based on parameter requirements (time, temperature and thickness). Afterwards, put the die in cooler, remove the diffusion layer after it is cooled. Weigh XC-72R carbon powder and add in proper amount of catalyst KMnO₄ and MnO₂. Weigh PTFE-30 and H₂O and then vibrate the mixture ultrasonically for 5 minutes (to mix them uniformly) into PTFE aqueous solution. Add the carbon powder and KMnO₄ and MnO₂ powders into PTFE solution. Agitate with the aid of ultrasonic oscillator. Add in proper amount of methanol and iso-propanol; agitate manually and then with the aid of ultrasonic device for 30 minutes (in liquid state for spraying purpose). Spray the resulting liquid on diffusion layer according to the required. Place the coated specimen in the oven and sinter for 20-30 min at 350° C., and then take out the air cathode electrode, after it cools down at constant pressure.

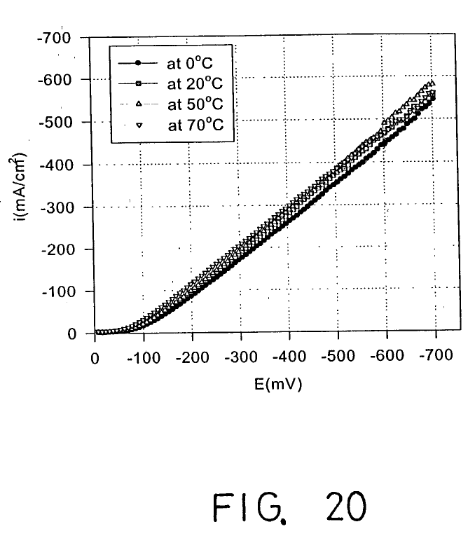

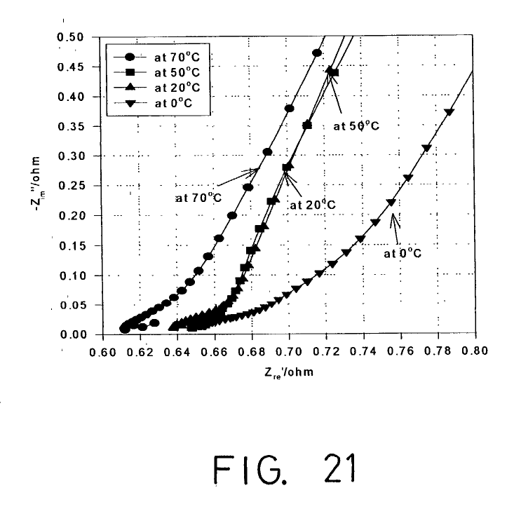

Carry out electrical testing on air cathode electrode completed above to understand its performance. Start by scanning open-circuit voltage (E_{ocv}) in the direction of cathode to obtain I-V curve of electrode. For testing, apply two ABS boards each to the exterior of both sides of air cathode electrode and control their reaction area to 1 cm² to measure the current density (mA/cm²) of air cathode electrode under different potentials. As shown in FIGS. 20 and 21, the higher the temperature, the higher the polarization current of air cathode electrode and the lower the resistance (R_{b}), meaning the better the electrode performance. The resistance (R_{b}) of the air electrode of this embodiment was at between 0.6-0.7 ohm.

Embodiment 5 Preparation of Polymer Zn-Air Battery and Testing of Performance

(1) Comparison of Zn-Air Batteries with Different Separators

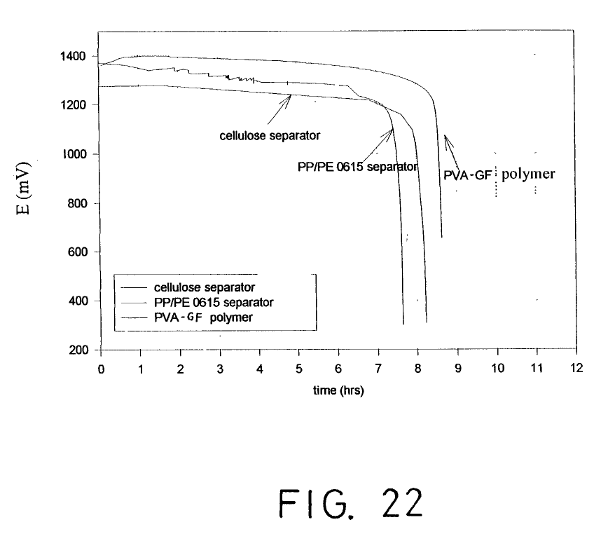

Prepare 2.5 g zinc gel containing 70 wt % zinc powder as a anode and the air electrode prepared as a cathode to assemble zinc-air batteries using PP/PE and cellulose as separator respectively. In addition, take the PVA-GF polymer electrolyte from Embodiment 1 herein to replace the aforesaid PP/PE or cellulose separator in the assembly of another zinc-air battery, and compare the property of different batteries. Keep the theoretical capacity of the batteries at 1,500 mAh and discharge at the rate of C/10 (at 150 mA) at ambient temperature. The results are shown in FIG. 22. Table 4 compares the electrical testing of zinc-air batteries using different electrolytes. In FIG. 22 at the discharge rate of C/10, the discharge time of Zn-air battery using PP/PE separator was 7.8 hours and its utilization rate was 75%; the discharge time of Zn-air battery using cellulose separator was 8.2 hours and its utilization rate was merely 78.85%; and the discharge time of Zn-air battery using PVA-GF polymer electrolyte film of Embodiment 1 herein was 8.7 hours and its utilization rate reached 83.65%.

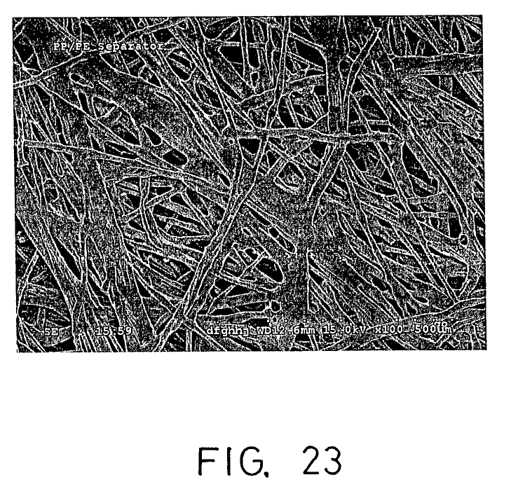

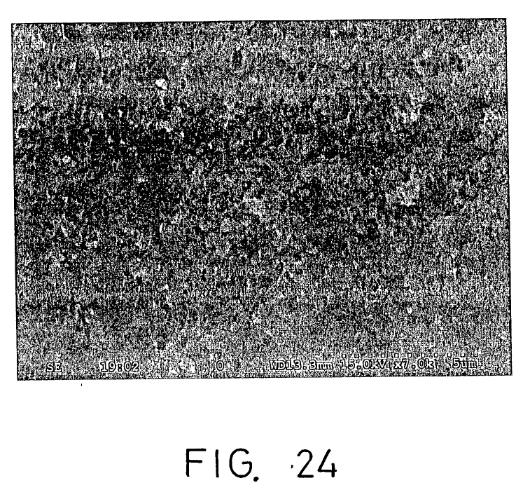

The reason for the significant discrepancy in utilization rate was that the PP/PE or cellulose used in commercially available alkaline battery had holes in the size of 20˜30 μm, as shown in FIG. 23. When the battery discharged, the zinc anode would expand after discharge and the zinc was turned into zinc oxide (ZnO), which, due to expansion and squeeze of the electrode, would enter the other electrode along the holes and bring about short circuit. But the pin holes of PVA-GF electrolyte with size 0.1˜0.2 μm. As shown in FIG. 24, small holes can block the penetration of Zn(OH)₄⁻² to prevent short circuit. When the composite PVA-GF film electrolyte was used as electrolyte and separator, temporary coordination bond was formed due to the dipole force generated between the polymer chain and ions, and ions were conducted through the flexibility of polymer chain. As a result, the expansion of zinc electrode wouldn't lead to short circuit due to the presence of PVA-GF polymer electrolyte film. Thus PVA-GF has higher utilization rate than conventional separators.

TABLE 4
Discharge results of Zn-air batteries using different separators

| | Cycle | | |
|---|---|---|---|
| | Zn-air + PP/PE | Zn-air + | Zn-air + PVA-GF solid |
| Item | 0615 | cellulose | polymer electrolyte |
| Theoretical | 1560 | 1560 | 1560 |
| capacity | | | |
| (mAh) | | | |
| Discharge | 150 | 150 | 150 |
| current (mA) | | | |
| Discharge time | 7.8 | 8.2 | 8.7 |
| (hrs) | | | |
| Actual | 1170 | 1230 | 1305 |
| capacity | | | |
| (mAh) | | | |
| Utilization rate | 75 | 78.85 | 83.65 |
| (%) | | | |

(2) Performance of Zn-Air Battery Under Different Discharge Rates

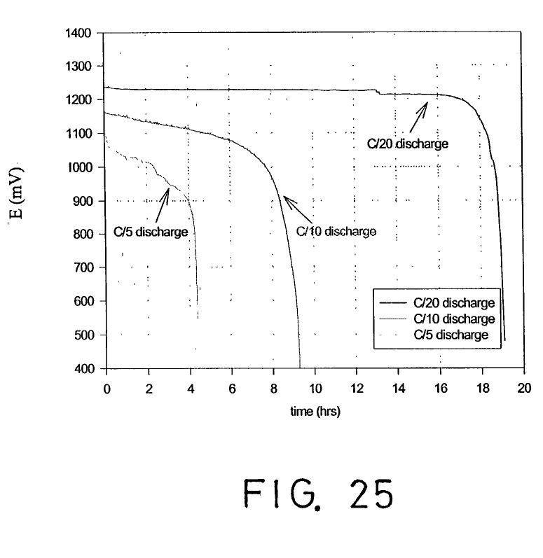

Prepare 2.5 g zinc gel containing 70 wt % zinc powder as a anode, and air electrode as a cathode to assemble Zn-air batteries using PVA-GF electrolyte of Embodiment 1 herein as electrolyte and separator. The theoretical capacity of battery was 1500 mAh. At the discharge rate of C/5, the battery's utilization rate reached 82.88%; at the rate of C/10, the utilization rate of zinc electrode was 89.9%; at the rate of C/20, the utilization rate of zinc electrode could reach 91.37%. FIG. 25 is the battery discharge curve. Table 5 depicts the results at different C-rates. The utilization rate of Zn-air battery of this invention was over 80% no matter whether it was discharged at high or low rate, which will make it a competitive primary cell in the market.

TABLE 5
Performance of polymer Zn-air battery of this invention at different
discharge rates

| | Rate | | |
|---|---|---|---|
| Item | C/5 | C/10 | C/20 |
| Theoretical | 1560 | 1560 | 1560 |
| capacity | | | |
| (mAh) | | | |
| Discharge | 300 | 150 | 75 |
| current (mA) | | | |
| Discharge time | 4.31 | 9.35 | 19.08 |
| (hrs) | | | |
| Actual | 1293 | 1402.5 | 1431 |
| capacity | | | |
| (mAh) | | | |
| Utilization rate | 82.88 | 89.90 | 91.37 |
| (%) | | | |

(3) Performance of Polymer Zn-Air Battery Under Different Temperature

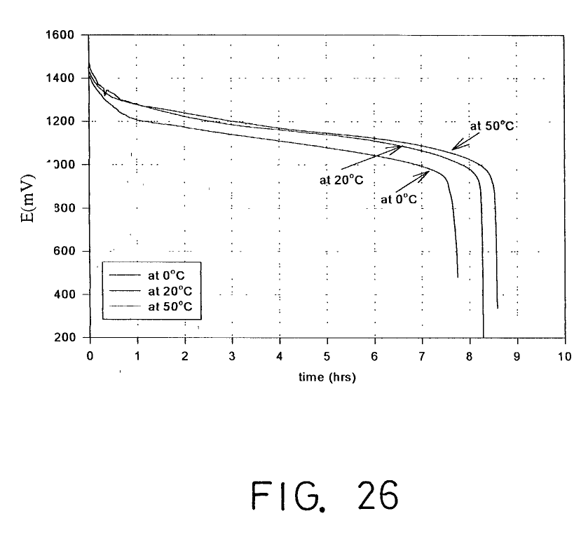

Prepare 2.5 g zinc gel containing 70 wt % zinc powder as a anode, and the air electrode as a cathode to assemble Zn-air battery using PVA-GF electrolyte of Embodiment 1 herein as electrolyte and separator and test its performance under different temperature environment (0° C., 20° C., 50° C.). The theoretical capacity of the battery was 1,500 mAh. FIG. 26 shows the discharge curves of battery at different temperatures. Table 6 depicts the utilization rate (%) of battery under different temperatures. At 0° C., zinc electrode utilization rate was 75%; at 20° C., zinc electrode utilization rate was 78.65%; at 50° C., zinc electrode utilization rate was 83.65%, displaying that the battery performs better at higher temperature. In low-temperature environment, the battery of this invention is still able to maintain utilization rate of over 70%.

TABLE 6
Performance of polymer Zn-air battery of this invention at different
temperature

| | T (° C.) | | |
|---|---|---|---|
| Item | 0 | 20 | 50 |
| Theoretical capacity | 1560 | 1560 | 1560 |
| (mAh) | | | |
| Discharge current (mA) | 150 | 150 | 150 |
| Discharge time (hrs) | 7.8 | 8.2 | 8.7 |
| Actual capacity (mAh) | 1170 | 1230 | 1305 |
| Utilization rate (%) | 75% | 78.85% | 83.65% |

(4) Analysis of Resistance/Impedance of Battery

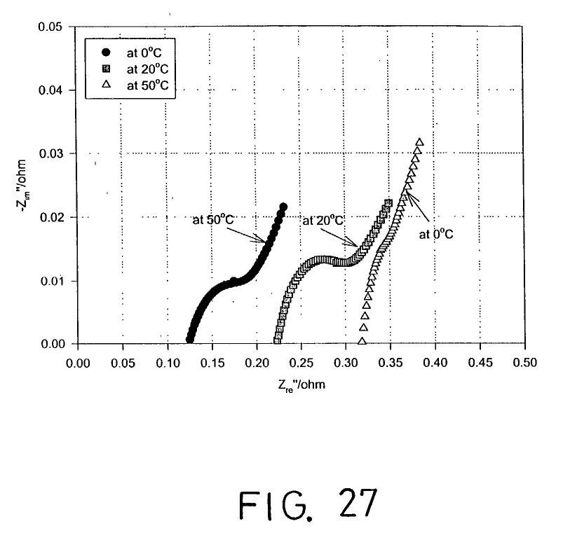

Prepare 2.5 g zinc gel containing 70 wt % zinc powder as a anode, and the air electrode as a cathode assemble Zn-air battery using PVA-GF electrolyte of Embodiment 1 herein as electrolyte and separator. Use Autolab FRA system to measure the resistance/impedance of alternating current (AC) under different temperatures (0° C., 20° C., 50° C.). FIG. 27 depicts the analysis results of resistance of the solid polymer Zn-air battery. Table 7 depicts the resistance values of battery under different temperatures. The higher the temperature in the environment, the lower AC resistance of the battery, indicating that the battery has less resistance at high-temperature environment, and relatively, its performance is better than that under low temperature, due to the fact that the resistance of PVA-GF solid polymer electrolyte is higher under low-temperature environment as shown in Table 7.

TABLE 7
Resistance of polymer Zn-air battery of this invention at different
temperature

| | T (° C.) | | |
|---|---|---|---|
| Resistance | 0 | 20 | 50 |
| R_{b} (ohm) | 0.32 | 0.225 | 0.125 |

While the invention has been described with reference to a preferred embodiment thereof, it is to be understood that modifications or variations may be easily made without departing from the spirit of this invention, which is defined by the appended claims.

What is claimed is:

1. Process for preparing solid alkaline polymer electrolyte, comprising the steps of:
(a) taking polyvinyl alcohol polymer with molecular weight between 2,000˜120,000 that comprises 10˜20% by weight to mix with water 50˜60% by weight under ambient temperature and in a closed environment;
(b) taking alkaline aqueous solution 15˜25% by weight to mix with water 10˜20% by weight under ambient temperature and in a closed environment;
(c) subsequently mixing the completely dissolved polyvinyl alcohol solution and alkaline metal aqueous together under ambient temperature that viscous solution generated thereof is fully agitated and heating the mixture in a closed container at 50˜100° C. to let it undergo co-polymerization blending, and then letting it cool in atmosphere; and
(d) spreading the cooled viscous polymer on the carrier tray to obtain desired thickness and then placing the tray in temperature/humidity chamber for 30˜60 minutes under the temperature of 40˜80° C. and humidity of 20˜50 RH % to turn it into solid state polymer film, and then leaving the carrier tray in atmosphere where the polymer electrolyte film may be removed with ease.

2. The process according to claim 1 wherein said alkaline metal solution may be KOH, NaOH, LiOH or its mixture.

3. The process according to claim 1 wherein said polyvinyl alcohol polymer preferably has average molecular weight of 5,000˜100,000.

4. The process according to claim 1 wherein glass fiber cloth with thickness of 20 μm ˜400 μm may be added in the process to enhance mechanical strength and thermo-chemical and electrochemical stability of the solid polymer electrolyte.

5. The process according to claim 1 wherein said polyvinyl alcohol polymer may be added with some micro or nano-particle oxides, such as γ-Al₂O₃, TiO₂, ZrO₂ or SiO₂.

6. The process according to claim 1 wherein the optimal condition for temperature/humidity chamber in step (d) is 50° C. temperature and 30 RH %.

7. Process for electrolytic dendritic zinc powder with high specific surface area, comprising the steps of:
(a) dissolving 5˜15 wt % zinc oxide powder in alkaline solution under the temperature of 30˜90° C., which is then electrolyzed into dendritic zinc powder under specific conditions with current density of 20˜300 mA/cm² and with the negative electrode being nickel plate;
(b) scrapping the electroplated zinc powder from the negative electrode, rinsing it with ultra-pure D.I. water, then vibrating it ultrasonically and filtering it; repeating the rinsing 5˜10 times; and
(c) washing the zinc powder thoroughly to prevent the leftover of electroplating fluid that will cause oxidation; drying the zinc powder and storing it in vacuum oven, packing to prevent oxidation.

8. The process according to claim 1 wherein said alkaline metal solution may be NaOH, KOH, LiOH or its mixture.

9. Process for zinc gel anode, comprising the steps of:
(a) weighing proper amount of hydrogen inhibitors, adding in alkaline metal solution and mixing to let the inhibitor distribution uniformly; and
(b) adding 1˜7 wt % dendritic zinc powder into the solution prepared in the foregoing step and vibrating the mixture in ultrasonic device, then adding 0.5˜10 wt % polymer gelling agent and mixing uniformly into gel.

10. The process according to claim 9 wherein said hydrogen inhibitor may be zinc oxide, indium acetate, magnesium oxide, calcium oxide or barium oxide.

11. The process according to claim 9 where said polymer gelling agent may be CMC, PVA, starch, poly-acrylic polymer gelling agent or cellulose, etc.

12. The process according to claim 9 wherein the optimum amount of said gelling agent is 1˜2 wt %.

13. Process for diffusion layer of air cathode electrode, comprising the steps of:
(a) weighing proper amount of dispersing agent Triton-X, polytetraflouroethylene (PTFE) and water and mixing them uniformly, and then putting the mixture together with the vessel into ultrasonic device to mix the mixture uniformly;
(b) weighing hydrophobic acetylene carbon powder and adding it into the aforesaid mixture, mixing with ultrasonic device, and then drying the resulting material in vacuum oven to remove the H₂O completely;
(c) grinding the material after drying and weighing the needed quantity according to the size of air cathode electrode; and
(d) placing a nickel screen collector in the die and coating the aforesaid material uniformly on said nickel screen, placing the die in thermal press to sinter the material, then putting the hot die in the cooler and removing the diffusion layer after cooling.

14. process for air cathode electrode, comprising the steps of:
(1) weighing hydrophilic carbon powder XC-72R and adding in proper amount of catalysts of KMnO₄ and MnO₂;
(2) weighing PTFE-30 and water and using ultrasonic oscillator to mix PTFE and water uniformly;
(3) mixing the resulting solutions in steps (a) and (b) above and vibrating ultrasonically, then adding in proper amount of alcohol solvent, agitating and vibrating with the aid of ultrasonic device; and
(4) spraying needed amount of resulting solution above on the diffusion layer, subjecting air cathode electrode with active layer sprayed on to high-temperature sintering at 320-350° C., then letting it cool under constant pressure to complete the making of air electrode.
